(19) United States
(12) Patent Application Publication
(10) Pub. No.: US 2009/0164289 A1
(43) Pub. Date: Jun. 25, 2009

(54) CALL CENTER SCHEDULE COMPLIANCE MANAGEMENT

(75) Inventors: Thomas M. Minnich, JR., Round Rock, TX (US); Ted Alan Wrenn, JR., Round Rock, TX (US)

Correspondence Address: HAYNES AND BOONE, LLP;IP Section, 2323 Victory Avenue, Suite 700, Dallas, TX, 75219, US

(73) Assignee: DELL PRODUCTS L.P., Round Rock, TX (US)

(21) Appl. No.: 11/959,690

(22) Filed: Dec. 19, 2007

(51) Int. Cl. G06Q 10/00

(52) U.S. Cl. 705/9; 705/7

(57) ABSTRACT

A method for call center schedule compliance management includes an information handling system (IHS) obtaining schedule information. The schedule information is associated with a schedule of an agent. The IHS obtains activity information. The activity information is associated with an activity of the agent. The IHS compares the schedule information with the activity information to determine whether a schedule violation has occurred. The IHS produces schedule violation information in response to determining that the schedule violation has occurred. The IHS analyzes the schedule violation information.

### CROSS REFERENCE TO RELATED APPLICATIONS

The present application is related to U.S. Utility application Ser. No. ______ attorney docket number 16356.1086 (DC-13556), filed on ______, the disclosure which is incorporated herein by reference.

### BACKGROUND

The present disclosure relates generally to information handling systems, and more particularly to call center schedule compliance management.

As the value and use of information continues to increase, individuals and businesses seek additional ways to process and store information. One option is an information handling system (IHS). An IHS generally processes, compiles, stores, and/or communicates information or data for business, personal, or other purposes. Because technology and information handling needs and requirements may vary between different applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, airline reservations, enterprise data storage, or global communications. In addition, IHSs may include a variety of hardware and software components that may be configured to process, store, and communicate information and may include one or more computer systems, data storage systems, and networking systems.

Call centers are often used to provide service to customers. Employees of a call center may be scheduled to answer phone calls during certain time periods. However, it may be common for many employees to not comply with a schedule by, for example, arriving late, leaving early, taking breaks longer than scheduled, or taking breaks otherwise not in accordance with the schedule. Such non-compliances with schedules can have a negative impact on the level of service that the call center can provide to the customers.

Accordingly, it would be desirable to provide improved call center schedule compliance management to reduce the problems set forth above.

### SUMMARY

According to one embodiment, a method for call center schedule compliance management is disclosed. The method includes an information handling system (IHS) obtaining schedule information. The schedule information is associated with a schedule of an agent. The IHS obtains activity information. The activity information is associated with an activity of the agent. The IHS compares the schedule information with the activity information to determine whether a schedule violation has occurred. The IHS produces schedule violation information in response to determining that the schedule violation has occurred. The IHS analyzes the schedule violation information.

### BRIEF DESCRIPTION OF THE DRAWINGS

FIG. 1a illustrates an embodiment of an information handling system (IHS).

FIG. 1b illustrates an embodiment of a system for managing call center schedule compliance.

FIGS. 2a and 2b illustrate an embodiment of a first method to manage call center schedule compliance using the system of FIG. 1b.

FIG. 2c illustrates an embodiment of a schedule violation e-mail used in the method of FIGS. 2a and 2b.

FIG. 2d illustrates an embodiment of a group violation status web page used in the method of FIGS. 2a and 2b.

FIG. 2e illustrates an embodiment of an individual violation status web page used in the method of FIGS. 2a and 2b.

FIG. 2f illustrates an embodiment of a schedule violation removal confirmation e-mail used in the method of FIGS. 2a and 2b.

FIG. 2g illustrates an embodiment of an area manager override request e-mail used in the method of FIGS. 2a and 2b.

### DETAILED DESCRIPTION

For purposes of this disclosure, an IHS may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an IHS may be a personal computer, a PDA, a consumer electronic device, a network server or storage device, a switch router or other network communication device, or any other suitable device and may vary in size, shape, performance, functionality, and price. The IHS may include memory, one or more processing resources such as a central processing unit (CPU) or hardware or software control logic. Additional components of the IHS may include one or more storage devices, one or more communications ports for communicating with external devices as well as various input and output (I/O) devices, such as a keyboard, a mouse, and a video display. The IHS may also include one or more buses operable to transmit communications between the various hardware components.

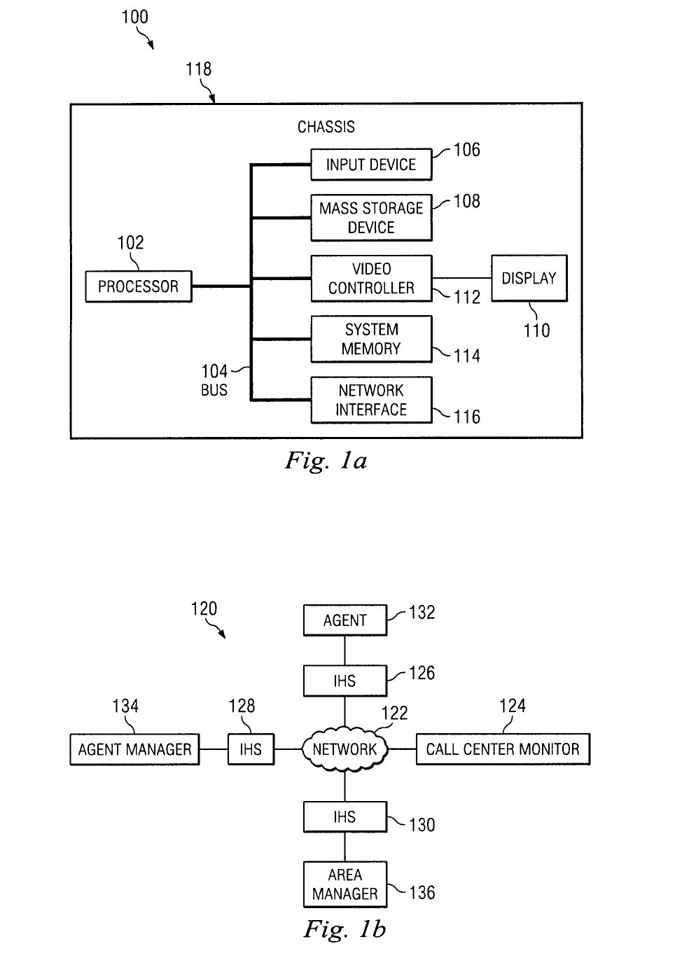

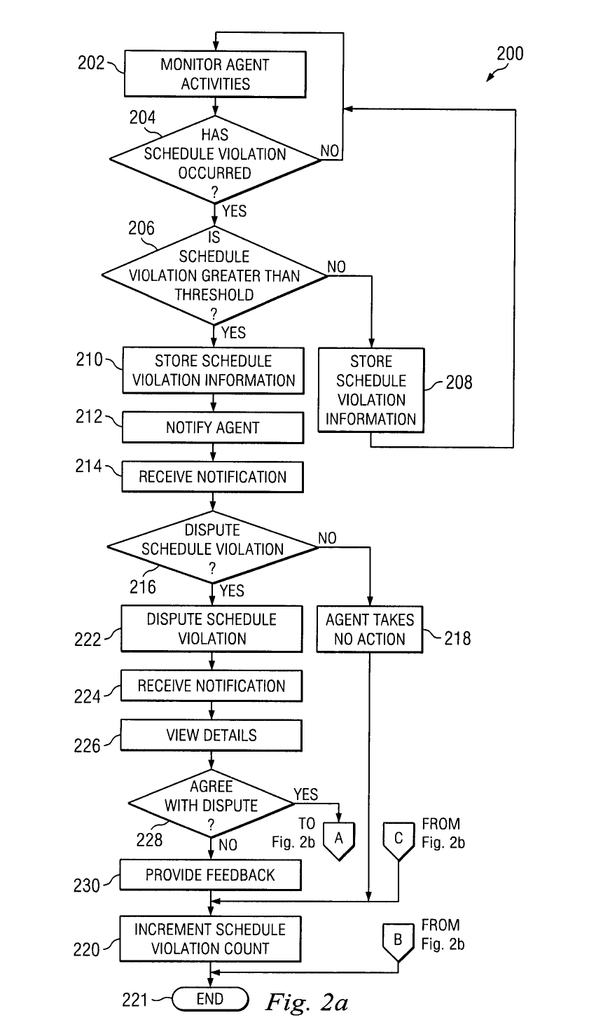

In one embodiment, IHS 100, FIG. 1, includes a processor 102, which is connected to a bus 104. Bus 104 serves as a connection between processor 102 and other components of computer system 100. An input device 106 is coupled to processor 102 to provide input to processor 102. Examples of input devices include keyboards, touchscreens, and pointing devices such as mice, trackballs and trackpads. Programs and data are stored on a mass storage device 108, which is coupled to processor 102. Mass storage devices include such devices as hard disks, optical disks, magneto-optical drives, floppy drives and the like. IHS 100 further includes a display 110, which is coupled to processor 102 by a video controller 112. A system memory 114 is coupled to processor 102 to provide the processor 102 with fast storage to facilitate execution of computer programs by processor 102. A network interface 116 is coupled to the processor 102 to allow the processor 102 to connect to a network. In an embodiment, a chassis 118 houses some or all of the components of IHS 100. It should be understood that other buses and intermediate circuits can be deployed between the components described above and processor 102 to facilitate interconnection between the components and the processor 102.

Referring now to FIG. 1b, an embodiment of a system 120 for managing call center schedule compliance is illustrated. The system 120 includes a network 122 (e.g., a Transport Control Protocol/Internet Protocol (TCP/IP) network), which is coupled to a call center monitor (CCM) 124 and IHSs 126, 128, and 130. Each of the CCM 124 and the IHSs 126,128, and 130 may include an IHS similar to the IHS 100, and accordingly each may communicate with each other over the network 122. The IHSs 126, 128, and 130 are coupled to and used by an agent 132, an agent manager 134, and an area manager 136, respectively, who may be employees of a call center and/or a provider. The agent 132 be responsible for communicating with customers of the provider through telephone and/or e-mail. The agent manager 134 may be responsible for managing the agent 132. The area manager 136 may be responsible for managing the agent manager 134 and the agent 132. The CCM 124, the agent manager 134, and/or the area manager 136 may be responsible for monitoring and/or administrating operations of the call center. The CCM 124 may include a variety of software, such as a web site hosted on a web server, which may be accessible by the agent 132, the agent manager 134, and the area manager 136 through the IHS 126, the IHS 128, and the IHS 130, respectively.

For clarity, only one network, one CCM, three IHSs, one agent, one agent manager, and one area manager are illustrated in FIG. 1b. However, it should be understood that any plurality of networks, CCMs, IHSs, agents, managers, and call centers may be used in accordance with the present invention.

The call center may have one or more service level goals for one or more customer segments. For example, one customer segment might include business customers for whom the service level goals may include answering 90% of telephone calls from the customers within two minutes. A second customer segment might include, for example, residential customers for whom the service level goals may include answering 90% of telephone calls within five minutes. In an embodiment, the call center may support only one customer segment. In an alternative embodiment, the call center may support a plurality of customer segments.

In order for the call center to be able to support the one or more service level goals, the agent 132 may be expected to work in accordance with a schedule. The schedule may include times in which the agent 132 is expected to be available to receive customer calls. The schedule may further include times in which the agent 132 is expected to take breaks such as, for example, lunches and/or any other types of scheduled breaks or planned outages known in the art.

The CCM 124 may monitor various activities of the agent 132. Activities of the agent 132 may include starting a work shift, ending a work shift, starting a break, or ending a break. In an embodiment, the agent 132 may be expected to notify the CCM 124 of some or all of the activities of the agent 132. Notifying the CCM 124 may include logging into or out of the IHS 126, logging into or out of an application on the IHS 126, accessing an application on the IHS 126, logging into or out of a web page provided by the CCM 124, accessing a web page provided by the CCM 124, and/or a variety of other types of notifications known in the art. Alternatively, the CCM 124 may monitor the activities of the agent 132 without the agent 132 notifying the CCM 124, or in a manner transparent to the agent 132.

The CCM 124 may compare the activities of the agent 132 with the schedule to determine whether the agent 132 is complying with the schedule. If the agent 132 does not comply with the schedule, the CCM 124 may determine that a schedule violation has occurred. A schedule violation may include a variety of schedule non-compliance situations such as a late login, an early logout, a break push, a break pull, or a break overage. A late login may include an occurrence of the agent 132 reporting to work (e.g., logging in to the call center and/or the CCM 124) after a scheduled shift start time. An early logout may include an occurrence of the agent 132 leaving work (e.g., logging out from the call center and/or the CCM 124) before a scheduled shift end time. A break push may include an occurrence of the agent 132 not taking advantage of a first opportunity to take a break on or shortly after a scheduled break start time, resulting in the agent 132 starting the break unnecessarily late. A break pull may include an occurrence of the agent 132 starting a break before a scheduled break start time. A break overage may include an occurrence of the agent 132 taking a break that is longer than a scheduled break, resulting in the agent 132 returning from the break later than scheduled.

In an embodiment, the CCM 124 may calculate a schedule violation count associated with the agent 132. The schedule violation count may include the total number of schedule violations made by the agent 132 during a recent time period, such as during the previous 90 days.

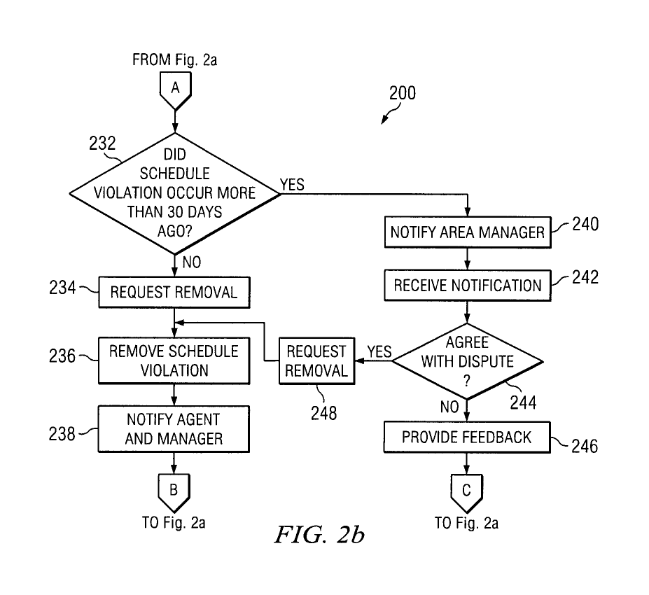

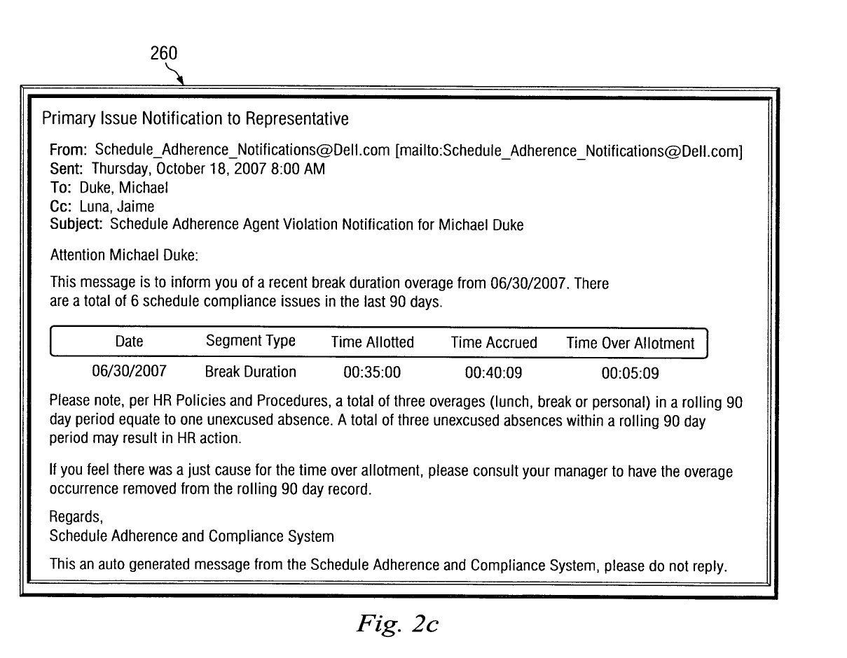

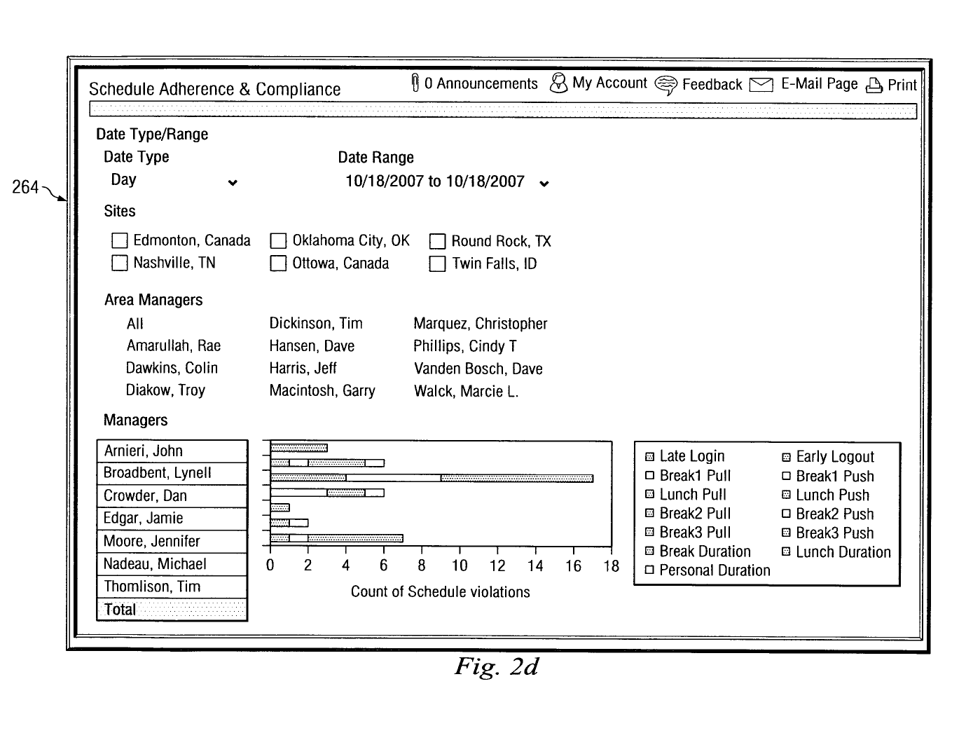

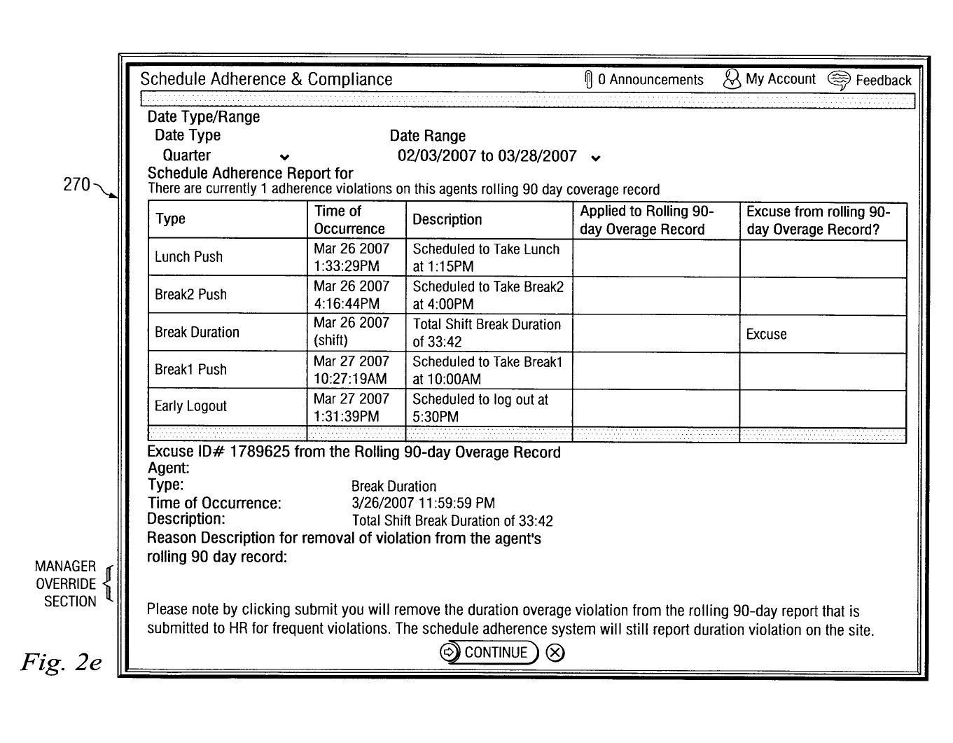

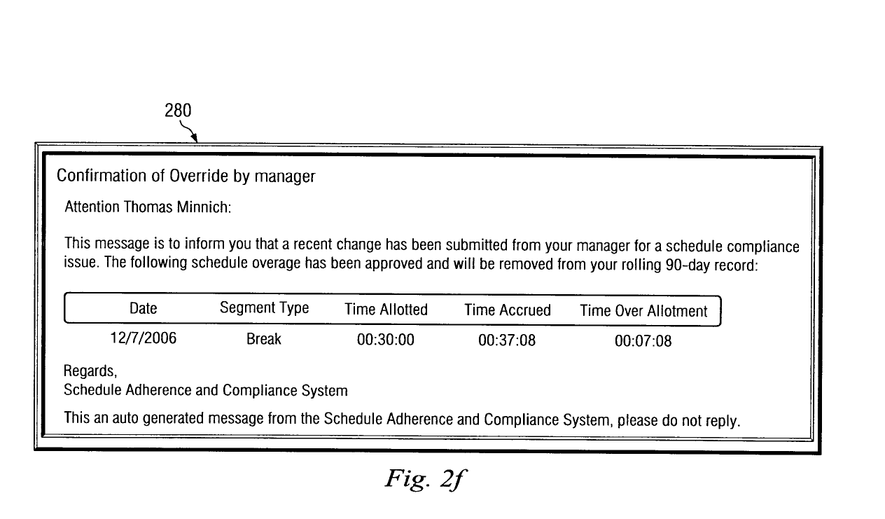

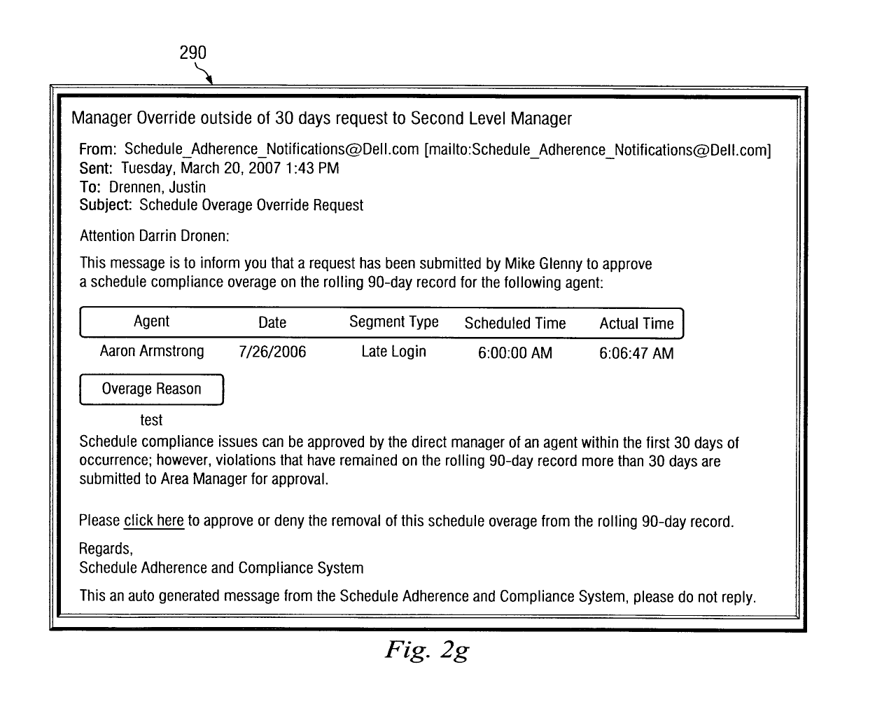

Referring now to FIGS. 2a and 2b, an embodiment of a method 200 to manage call center schedule compliance is illustrated. The method 200 begins at block 202 where the CCM 124 monitors activities of the agent 132 for schedule violations. The monitoring for scheduling violations may be similar to as described above.

The method 200 then proceeds to decision block 204 where the CCM 124 determines whether a schedule violation has occurred. In an embodiment, the determination may include comparing the activities of the agent 132 with the schedule of the agent 132, as described above. In an embodiment, the determination may occur periodically such as, for example, once per day, once per work shift, once per scheduled time interval, or continuously. If at decision block 204 the CCM 124 determines that a schedule violation has not occurred, the method 200 returns to block 202 where the CCM 124 monitors activities of the agent 132 for schedule violations.

If at decision block 204 the CCM 124 determines that a schedule violation has occurred, the method 200 proceeds to block 206 where the CCM 124 determines whether the schedule violation is greater than a particular threshold. The threshold may include a variable that indicates an amount of time in which the agent 132 is allowed to deviate from the schedule. For example, if the threshold is five minutes, and the agent is four minutes late, the schedule violation may be considered to be less than the threshold. Alternatively, for example, if the threshold is five minutes, and the agent is six minutes late, the schedule violation may be considered to be greater than the threshold. In an alternative embodiment, the CCM 124 may determine whether the schedule violation is greater than the threshold plus a constant value (e.g., 2 minutes). The threshold may be adaptable and/or configurable.

If at decision block 206 the CCM 124 determines that the schedule violation is not greater than a particular threshold, the method 200 proceeds to block 208 where the CCM 124 stores schedule violation information about the schedule violation in an agent record. The schedule violation information may include that the schedule violation is an acceptable violation (i.e., under the threshold). The agent record may include information about the agent 132, and may be stored in a database. The method 200 then returns to block 202 where the CCM 124 monitors activities of the agent 132 for schedule violations.

If at decision block 206 the CCM 124 determines that the schedule violation is greater than a particular threshold, the method 200 proceeds to block 210 where the CCM 124 stores schedule violation information. The schedule violation information may include that the schedule violation is an unacceptable violation (i.e., over the threshold). The schedule violation information may further include a violation ID (i.e., a unique identifier associated with the schedule violation), a time stamp, break details, an amount of time over the threshold, and other details about the schedule violation. In an embodiment, all or part of the schedule violation information may be stored in an agent record, described above with reference to decision block 208. In an embodiment, all or part of the schedule violation information may be stored in a violation database, which may include information about schedule violations made by numerous agents.

The method 200 then proceeds to block 212 where the CCM 124 sends a notification e-mail to the agent 132. The notification e-mail may inform the agent 132 about the schedule violation, and may further provide some or all of the schedule violation information, described above with reference to block 210. In an embodiment, the CCM 124 may further send a notification e-mail to the agent manager 134, the area manager 136, and/or a human resources (HR) representative, based on the schedule violation count, described above, of the agent 132. For example, if the schedule violation count is three, the CCM 124 may send a notification e-mail to the agent manager 134. Additionally, for example, if the schedule violation count is six, the CCM 124 may send a notification e-mail to the agent manager 134 and the area manager 136. Furthermore, for example, if the schedule violation count is nine, the CCM 124 may send a notification e-mail to the agent manager 134, the area manager 136, and the HR representative. In an embodiment, after receiving an e-mail notification, each of the agent manager 134, the area manager 136, and the HR representative may take corrective actions such as, for example, speaking with the agent 132, reprimanding the agent 132, or firing the agent 132, respectively. In an embodiment, sending the notification e-mail may include adding one or more of the recipients to a carbon-copy list of the notification e-mail to the agent 132. In an alternative embodiment, each of the agent 132, the agent manager 134, the area manager 136, and the HR representative may be notified using a mechanism other than e-mail such as, for example, a web site or an application. In an embodiment, the notification e-mail may include schedule violation e-mail 260, illustrated in FIG. 2c.

In an embodiment, the notifications may be configurable in a variety of ways. In an embodiment, some or all employees (e.g., the agent 132, the agent manager 134, or the area manager 136) may be enabled to configure the CCM 124 to notify some or all employees when one or more schedule violations occur meeting certain criteria. For example, the area manager 136 may be able to configure the CCM 124 to notify the agent manager 134 and the area manager 136 after every 10 schedule violations made by the agent 132. Additionally, for example, the agent manager 134 may be able to configure the CCM 124 to notify the agent manager 134 of every schedule violation made by the agent 132 that deviates from the schedule more than 60 minutes. In an embodiment, the notification may be sent in real time. For example, the notification may be sent simultaneously with the occurrence, detection, and/or recording of the schedule violation.

The method 200 then proceeds to block 214 where the agent 132 receives the notification e-mail from the CCM 124. The method 200 then proceeds to decision block 216 where the agent 132 determines whether to dispute the schedule violation. The agent 132 may desire to dispute the schedule violation if, for example, the agent 132 had a valid business reason for not complying with the schedule.

If at decision block 216 the agent 132 determines not to dispute the schedule violation, the method 200 proceeds to block 218 where the agent 132 does not dispute the schedule violation. In an embodiment, the agent 132 may take no action in order to not dispute the schedule violation. The method 200 then proceeds to block 220 where the schedule violation count, described above, of the agent 132 is incremented. In an embodiment, the schedule violation count may be included in the schedule violation information, described above with reference to block 210. The method 200 then ends at block 221.

If at decision block 216 the agent 132 determines to dispute the schedule violation, the method 200 proceeds to block 222 where the agent 132 disputes the schedule violation. Disputing the schedule violation may include requesting that the schedule violation be removed from the agent record. In an embodiment, the agent 132 may dispute the schedule violation by clicking a link in the notification e-mail from the CCM 124, or by accessing a web site provided by the CCM 124. In an embodiment, the agent 132 may dispute the schedule violation by contacting the agent manager 134 directly. The agent 132 may further provide details about the dispute such as a reason the schedule violation should be removed.

The method 200 then proceeds to block 224 where the agent manager 134 receives a notification e-mail including that the agent 132 disputes the schedule violation. The method 200 then proceeds to block 226 where the agent manager 134 uses a schedule adherence tool to view details related to the dispute and the schedule violation. The details may include information about the agent 132, information about the schedule violation, and information about the reason for the dispute. In an embodiment, the schedule adherence tool may be included on a web site provided by the CCM 124. In an embodiment, in order to view the details, the agent manager 134 may use the schedule adherence tool to browse or search by team or schedule violation ID. In an embodiment, the agent manager 134 may click a link in the notification e-mail from the CCM 124 to access the schedule adherence tool in order to view the details.

Referring now to FIG. 2d, in an embodiment, the CCM 124 may provide a group violation status web page 264 to the agent manager 134 to enable the agent manager 134 to view information about schedule violations made by a plurality of agents (e.g., including the agent 132). The group violation status web page 264 includes information about the number of schedule violations each agent has made, and the type of schedule violations (e.g., break push, break pull, late login, early logout, etc.). The agent manager 134 may filter the contents of the group violation status web page 264 using a variety of parameters including a date range, one or more site locations, and/or a manager. In an embodiment, the CCM 124 may provide a variety of other status reports relating to agents, schedules, schedule compliance, schedule adherence, and/or schedule violations. In an embodiment, the manager 134 may filter status reports by a variety of other filters known in the art.

The method 200 then proceeds to decision block 228 where the CCM 124 determines whether the agent manager 134 agrees with the dispute. In an embodiment, the agent manager 134 may indicate agreement or disagreement with the dispute to the CCM 124 using the schedule adherence tool. If at decision block 228 the CCM 124 determines that the agent manager 134 does not agree with the dispute, the method 200 proceeds to block 230 where the agent manager 134 provides feedback to the agent 134. The feedback may include information about why the manager 134 does not agree with the dispute. The method 200 then proceeds to block 220, described above, where the schedule violation count of the agent 132 is incremented.

If at decision block 228 the CCM 124 determines that the agent manager 134 agrees with the dispute, the method 200 proceeds to decision block 232 where the CCM 124 determines whether the schedule violation occurred more than 30 days ago. In an embodiment, an alternate value may be used. If at decision block 232 the CCM 124 determines that the schedule violation did not occur more than 30 days ago, the method 200 proceeds to block 234 where the agent manager 134 requests removal of the schedule violation from the agent record. The agent manager 134 may use the schedule adherence tool to request removal of the schedule violation. In an embodiment, the agent manager 134 may click a link and/or deselect a checkmark in the schedule adherence tool to request removal of the schedule violation. The agent manager 134 may further specify a reason for requesting removal of the schedule violation. In another embodiment, the schedule or agent record may be retroactively adjusted so as to indicate that a schedule violation did not occur due to a valid business reason, such as, for example, a need-you-now meeting, a fire drill, a safety inspection, and/or a variety of other valid business reasons known in the art. The retroactive adjustment may be initiated by the agent 132, the agent manager 134, and/or the area manager 136. The retroactive adjustment may be automatic.

Referring now to FIG. 2e, in an embodiment, the CCM 124 may provide an individual violation status web page 270 to the agent manager 134 to enable the agent manager 134 to view information about schedule violations made by the agent 132, and to request removal of one or more of the schedule violations. For each schedule violation made by the agent 132, the individual violation status web page 270 includes information about the type of schedule violation, a time of occurrence, a description, how the schedule violation count of the agent 132 is affected by the schedule violation, and a link to request removal of the schedule violation from the agent record. The individual violation status web page 270 further includes a form that enables the agent manager 134 to request removal of one or more of the schedule violations from the agent record.

The method 200 then proceeds to block 236 where the CCM 124 removes the schedule violation from the agent record. The method 200 then proceeds to block 238 where the CCM 124 sends a notification e-mail to the agent 132 and the agent manager 134. The notification e-mail may include that the schedule violation was removed from the agent record. In an embodiment, the notification e-mail may include schedule violation removal confirmation e-mail 280, illustrated in FIG. 2f. The method 200 then ends at block 221.

If at decision block 232 the CCM 124 determines that the schedule violation occurred more than 30 days ago, the method 200 proceeds to block 240 where the CCM 124 sends a notification e-mail to the area manager 136. In an embodiment, the notification e-mail may include area manager override request e-mail 290, illustrated in FIG. 2g. In an embodiment, the agent manager 134 may notify the CCM 124 to send the notification e-mail to the area manager 136. In another embodiment, the agent manager 134 may notify the area manager 136 directly.

The method 200 then proceeds to block 242 where the area manager 136 receives the notification e-mail from the CCM 124. The method 300 then proceeds to decision block 244 where the CCM 124 determines whether the area manager 136 agrees with the dispute. In an embodiment, the area manager 136 may indicate agreement or disagreement with the dispute to the CCM 124 using the schedule adherence tool. If at decision block 244 the CCM 124 determines that the area manager 136 does not agree with the dispute, the method 200 proceeds to block 246 where the area manager 136 provides feedback to the agent manager 134. The feedback may include information about why the area manager 136 does not agree with the dispute. The method 200 then proceeds to block 220, described above, where the schedule violation count of the agent 132 is incremented.

If at decision block 244 the CCM 124 determines that the area manager 136 agrees with the dispute, the method 200 proceeds to block 248 where the area manager 136 requests removal of the schedule violation from the agent record. The area manager 136 may use the schedule adherence tool to request removal of the schedule violation. In an embodiment, the area manager 136 may click a link and/or deselect a checkmark in the schedule adherence tool to request removal of the schedule violation. The area manager 136 may further specify a reason for requesting removal of the schedule violation. The method 200 then proceeds to block 236, described above, where the CCM 124 removes the schedule violation from the agent record.

Thus, embodiments are provided for improved call center schedule compliance management. Schedule violations made by agents are detected. Agents, managers, and HR representatives may be notified of the schedule violations, and may view status reports about the agents and their schedule violations and schedule compliances. The schedule violations may be disputed, excused, and/or removed from agent records and/or schedules.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

1. A method comprising:
obtaining schedule information, wherein the schedule information is associated with a schedule of an agent, and wherein the obtaining is performed by an information handling system (IHS);
obtaining activity information, wherein the activity information is associated with an activity of the agent, and wherein the obtaining is performed by the IHS;
determining whether a schedule violation has occurred by comparing the schedule information with the activity information, wherein the determining is performed by the IHS;
producing schedule violation information in response to determining that the schedule violation has occurred, wherein the producing is performed by the IHS; and
analyzing the schedule violation information, wherein the analyzing is performed by the IHS.

2. The method of claim 1, further comprising:
reporting that the schedule violation has occurred, wherein the reporting is performed by the IHS.

3. The method of claim 1, wherein the analyzing the schedule violation information includes determining whether the schedule violation is greater than a threshold.

4. The method of claim 3, wherein the threshold includes a time period.

5. The method of claim 1, wherein the analyzing the schedule violation information includes determining whether the schedule violation is an acceptable violation.

6. The method of claim 1, wherein the schedule violation information is stored in an agent record.

7. The method of claim 1, wherein the schedule violation information includes a time stamp and a violation identification, and wherein the violation identification includes a unique identifier associated with the schedule violation.

8. The method of claim 1, wherein the schedule violation information is stored in a violation database, wherein the violation database includes further schedule violation information associated with further agents, and wherein information in the violation database is filterable.

9. A method comprising:
determining whether a schedule violation has occurred by comparing a schedule of an agent to an activity of the agent, wherein an adaptable threshold is used to determine whether the schedule violation has occurred, and wherein the determining is performed by an information handling system (IHS);
reporting the schedule violation to a manager of the agent in response to determining that the schedule violation has occurred, wherein the reporting is performed in real-time by the IHS;
providing the manager to excuse the schedule violation, wherein the providing is performed by the IHS;
reporting the schedule violation to the agent in response to determining that the schedule violation has occurred, wherein the reporting is performed in real-time by the IHS;
providing the agent to dispute the schedule violation, wherein the providing is performed by the IHS;
storing schedule violation information in a database that includes a plurality of other schedule violation information for a plurality of other agents, wherein the database is filterable, and wherein the storing is performed by the IHS;
analyzing the schedule violation, wherein the schedule violation information is used to analyze the schedule violation, and wherein the analyzing is performed by the IHS;
determining whether the schedule violation was a result of an unplanned event, wherein the unplanned event included an excusable purpose, and wherein the determining is performed by the IHS; and
retroactively updating the schedule to include the unplanned event in response to determining that the schedule violation was a result of the unplanned event, wherein the updating is performed by the IHS.

10. An information handling system (IHS), comprising:
a processor; and
a memory coupled to the processor, wherein the memory includes computer-readable instructions executable by the processor to:
determine whether a schedule violation has occurred by comparing schedule information with activity information, wherein the schedule information is associated with a schedule of an agent, and wherein the activity information is associated with an activity of the agent; and
report the schedule violation in response to determining that the schedule violation occurred.

11. The IHS of claim 10, wherein the reporting the schedule violation includes sending a notification e-mail to the agent.

12. The IHS of claim 10, wherein the reporting the schedule violation includes sending a notification e-mail to one of a manager of the agent and a representative of the agent.

13. The IHS of claim 10, wherein the memory further includes computer-readable instructions executable by the processor to:
report schedule compliance information in response to determining that the schedule violation failed to occur.

14. The IHS of claim 13, wherein the memory further includes computer-readable instructions executable by the processor to:
store the schedule compliance information.

15. The IHS of claim 10, wherein the memory further includes computer-readable instructions executable by the processor to:
produce schedule violation information in response to determining that the schedule violation occurred.

16. The IHS of claim 10, wherein the schedule violation includes at least one of a late login, an early logout, a break push, a break pull, a lunch push, a lunch pull, and a duration overage.

17. A method comprising:
determining whether a schedule violation has occurred, wherein the schedule violation is associated with an agent, and wherein the determining is performed by an information handling system (IHS); and
reporting the schedule violation in response to determining that the schedule violation occurred, wherein the reporting is performed by the IHS.

18. The method of claim 17, further comprising:
providing the agent to dispute the schedule violation, wherein the providing is performed by the IHS.

19. The method of claim 17, further comprising:
providing a manager to excuse the schedule violation, wherein the providing is performed by the IHS.

20. The method of claim 17, further comprising:
retroactively updating an agent record of the agent in response to determining that the schedule violation was for a valid business reason, wherein the updating is performed by the IHS.
